(19) United States
(12) Patent Application Publication
(10) Pub. No.: US 2011/0233071 A1
(43) Pub. Date: Sep. 29, 2011

(54) ELECTROCHEMICAL METHOD FOR REDUCING MOLECULAR OXYGEN

(75) Inventors: Jens Assmann, Hilden (DE); Aurel Wolf, Wulfrath (DE); Leslaw Mileczko, Dormagen (DE); Alexander Karpenko, Leverkusen (DE); Volker Michele, Koln (DE)

(73) Assignee: BAYER TECHNOLOGOGY SERVICES GMBH, LEVERKUSEN (DE)

(21) Appl. No.: 13/131,166

(22) PCT Filed: Dec. 5, 2009
(86) PCT No.: PCT/EP2009/008699

§ 371 Date: May 25, 2011

(30) Foreign Application Priority Data
Dec. 18, 2008 (DE) 102008063727.0

(51) Int. Cl. C25B 1/02; C25B 9/08; B82Y 99/00

(52) U.S. Cl. 205/763; 204/252; 977/742

(57) ABSTRACT

Electrochemical process for the reduction of molecular oxygen in alkaline solutions in the presence of nitrogen-doped carbon nanotubes, in which no hydrogen peroxide forms as a by-product of the reduction.

The present invention relates to an electrochemical process for the reduction of molecular oxygen in alkaline solutions in the presence of nitrogen-doped carbon nanotubes, in which no hydrogen peroxide forms as a by-product of the reduction.

The necessity for the electrochemical reduction of molecular oxygen in solutions usually arises in relation, for example, to sodium chloride electrolysis processes or, for example, in metal-air batteries.

The reduction products of molecular oxygen which are desired in such electrochemical reduction reactions are usually oxygen ions which have a double negative charge and are usually present in the form of hydroxide ions in aqueous solutions. However, it is likewise generally known that the electrochemical reduction of molecular oxygen can also result in another reduction product which, depending on the conditions of the reduction process and depending on the electrode material, can be formed in smaller or larger amounts. This other reduction product is hydrogen peroxide.

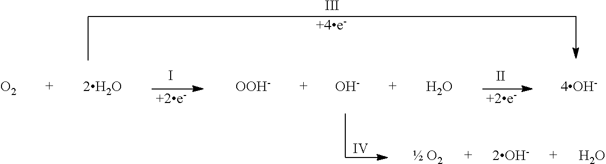

The formulae (I to W) shown above, according to which molecular oxygen can be electrochemically reduced to give oxygen ions having a double negative charge in the form of hydroxide ions, show that this can take place either with uptake of two electrons twice with the intermediate formation of a hydrogen peroxide anion (OOH⁻) according to the formulae (I and II) or directly with uptake of four electrons once according to formula (III). The theoretically possible, electrochemical reaction according to the formula (III) would be advantageous if it were to occur in a process for the reduction of molecular oxygen. The reason for this advantageousness is described below.

On the basis of the autoprotolysis of water, hydrogen peroxide would also automatically be present in aqueous solutions in addition to the abovementioned hydrogen peroxide anion.

Owing to its corrosive and oxidative properties, hydrogen peroxide is generally an undesired by-product in the reduction of molecular oxygen.

Moreover, in the case of the presence of hydrogen peroxide according to the formula (IV), a disproportionation reaction may occur without the uptake of further electrons, in which disproportionation reaction a proportion of molecular oxygen is concomitantly formed, which is undesired in the sense of the further reduction thereof.

The possibility of hydrogen peroxide formation generally imposes very narrow limits on the choice of the electrode materials for the electrochemical reduction of molecular oxygen for the abovementioned reasons regarding the corrosive properties of hydrogen peroxide.

With the use of economical, for example, carbon materials, such as carbon black or graphite, as support material for other electrode materials is frequently completely dispensed with because these generally promote the reaction according to the formula (I) and thus lead to greatly reduced lifetimes of the electrodes. Furthermore, the amount of oxygen ions having a double negative charge, for example in the form of hydroxide ions, is thereby smaller, owing to the possibility of the disproportionation reaction according to formula (IV).

Thus, O. Ichinose et al., in “Effect of silver catalyst on the activity and mechanism of a gas diffusion type oxygen cathode for chlor-alkali electrolysis”, in Journal of Applied Electrochemistry 34: 55-59 (2004), discloses that the use of carbon black and in particular electrodes comprising pure carbon black results in hydrogen peroxide being formed in large amounts in the experiment of the electrochemical reduction of molecular oxygen.

It is further disclosed that an electrochemical reduction of molecular oxygen can be carried out in the presence of a catalyst material in the form of a carbon black support laden with silver or of a pure carbon black support in a 32% strength by weight sodium hydroxide solution at temperatures of 60° C. or 80° C. Here, the formation of hydrogen peroxide on the carbon black material leads to cracking in the electrode, which is recognized as being disadvantageous. O. Ichinose et al. explain that the transfer of only two electrons to the molecular oxygen can be improved to the transfer of four electrons by the addition of silver to the carbon black, so that less hydrogen peroxide is formed, which in turn is advantageous.

The process variants presented in the disclosure by O. Ichinose et al. are, however, disadvantageous in that the addition of silver to the electrode material is required for achieving the desired transfer of four electrons. However, silver is a noble metal whose use as a constituent of electrodes is economically unattractive. Furthermore, complete suppression of the formation of hydrogen peroxide is not possible since proportions of molecular oxygen always come into contact with the carbon black support and are reduced there according to the formula (I) to hydrogen peroxide in the aqueous solution. This in turn is suitable for damaging the electrode material.

L. Lipp in “Peroxide formation in a zero-gap chlor-alkali cell with an oxygen-depolarized cathode”, in Journal of Applied Electrochemistry 35:1015-1024 (2005), also comes to a conclusion similar to that of O. Ichinose et al. regarding the formation of hydrogen peroxide. However, L. Lipp et al. find that the effects described also occur in the case of an electrode laden with platinum and containing carbon black. It is further disclosed that, by applying higher voltages and/or higher current densities, a part of the resulting hydrogen peroxide can be reduced further to the desired oxygen ions having a double negative charge, for example in the form of hydroxide ions. The possibility of the sequence of reactions according to the formula (I) and/or (II) is described thereby. Since, however, the reaction takes place according to the formula (I), the reaction according to the formula (IV) likewise cannot be ruled out, which in turn leads to a reduction in the yield of oxygen ions having a double negative charge in the form of the abovementioned hydroxide ions. The process variants disclosed in L. Lipp et al. therefore have the same economic and technical disadvantages as those in the disclosure according to O. Ichinose et al.

A further development of processes for the reduction of molecular oxygen is disclosed by P. Matter et al. in “Oxygen reduction reaction activity and surface properties of nanostructured nitrogen-containing carbon”, in Journal of Molecular Catalysis A: Chemical 264: 73-81 (2007). Here, it is found that nitrogen-containing carbon modifications which are obtained by catalytic deposition of vapours comprising acetonitrile on support materials, such as silica, magnesium oxide, which in turn contain iron, cobalt or nickel as a catalytically active component, have a catalytic activity for the reduction of molecular oxygen. The process for the reduction of molecular oxygen which is disclosed by P. Matter et al. is characterized in that it is carried out in a 0.5 molar sulphuric acid solution.

It is also disclosed that, depending on the support material and/or on the catalytically active component present thereon and intended for the preparation of the nitrogen-containing carbon modifications, a greater or smaller amount of hydrogen peroxide is formed as a by-product. In general, however, it is presume by P. Matter et al. that the formation of hydrogen peroxide occurs to a lesser extent by means of the nitrogen-containing carbon modifications than by means of the abovementioned other constituents which originate from the preparation processes thereof.

P. Matter et al. further disclose the nitrogen-containing carbon modifications which are active for the electrochemical, catalytic reduction of molecular oxygen have proportions of pyridinic and quaternary nitrogen.

P. Matter et al. do not disclose that the abovementioned reduction of molecular oxygen is also possible in alkaline solutions. Furthermore, according to the process variants disclosed in P. Matter et al., the disproportionation reaction according to the formula (IV) likewise takes place as a result of the presence of hydrogen peroxide after the formation thereof by the reaction according to formula (I), which reduces the amount of oxygen ions having a double negative charge, for example in the form of hydroxide ions.

The process disclosed in P. Matter et al. is therefore to be regarded as disadvantageous because it firstly does not permit applicability of the process to industry relevant processes, such as, for example, the sodium chloride electrolysis processes in which the electrochemical reduction of molecular oxygen is of considerable importance and which are generally carried out in alkaline media and since it secondly cannot prevent the formation of hydrogen peroxide, with the result that the yield of oxygen ions having a double negative charge, for example in the form of hydroxide ions, is reduced by the reaction according to the formula (IV).

In a summary of the prior art relating to the catalytic properties of nitrogen-containing carbon modifications, Y. Shao et al., in “Nitrogen-doped carbon nanostructures and their composites as catalytic materials for proton exchange membrane fuel cell” in Applied Catalysis B: Environmental 79: 89-99 (2008), disclosed that the abovementioned nitrogen-containing carbon modifications are generally also suitable in alkaline solutions for the reduction of molecular oxygen.

Specifically, however, it is stated that, in the processes disclosed to date, decomposition of hydrogen peroxide to give oxygen ions having a double negative charge takes place. Accordingly, a decomposition can only be understood as meaning the presence of a disproportionation reaction according to the formula (IV), which reduces the yield of oxygen ions having a double negative charge, for example in the form of hydroxide ions, in the manner described above and is therefore disadvantageous. It is therefore in any case a reaction sequence according to the formulae (I, II and IV).

It is not disclosed that a direct reduction of molecular oxygen to give oxygen ions having a double negative charge takes place without formation of the intermediate product hydrogen peroxide.

The process variants disclosed by Y. Shao et. al. are generally also disadvantageous, like those in which a decomposition of the hydrogen peroxide does not take place since hydrogen peroxide is formed in any case and can, in the abovementioned manner, damage the electrode materials used.

Y. Shao et al. refer, for example, to S. Maldonado et al., who, in “Influence of Nitrogen Doping on Oxygen Reduction Electrocatalysis at Carbon Nanofiber Electrodes”, in Journal of Physical Chemistry B 109: 4707-4716 (2005), disclose that it is possible to disproportionate hydrogen peroxide with nitrogen-containing carbon modifications to give the desired oxygen ions having a double negative charge.

It is further disclosed that this disproportionation is responsible for defects in the carbon structure, caused by the nitrogen doping. The abovementioned disproportionation of hydrogen peroxide to give oxygen ions having a double negative charge is, according to the disclosure by S. Maldonado et al., carried out in potassium nitrate solutions or in potassium hydroxide solutions. From this too it follows that the process variants disclosed in S. Maldonado et al. comprise a reaction sequence according to the formulae (I, II and optionally IV). S. Maldonado moreover states that, in solutions having a pH of less than 10, explicitly a reaction according to the formula (I) takes place, the rate of the reduction being determined by the adsorbed superoxide (a molecular oxygen radical having a single negative charge). It is further disclosed that, in solutions with a pH greater than 10, the adsorption process of the abovementioned superoxide is hindered. Here too, however, a reaction according to the formula (I) and subsequently according to the formula (IV) is disclosed, although this takes place more slowly.

Accordingly, S. Maldonado et al. also do not disclose that a direct reduction of the molecular oxygen can take place without the intermediate formation of peroxide compounds, which leads to the abovementioned disadvantages of such processes.

It is therefore the object to provide a process for the reduction of molecular oxygen which permits the abovementioned reduction without the formation of hydrogen peroxide in alkaline solutions.

It was surprisingly found that a process for the electrochemical reduction of molecular oxygen to give oxygen ions having a double negative charge in solutions having a pH greater than or equal to 8, characterized in that the molecular oxygen in such solutions is brought into contact with nitrogen-doped carbon nanotubes having a proportion of pyridinic and quaternary nitrogen with application of a voltage, is capable of achieving this object.

In relation to the present invention, the abovementioned oxygen ions having a double negative charge also designate oxygen ions which have a double negative charge and may be present in the abovementioned solutions having a pH greater than or equal to 8 in a form bound to hydrogen ions. Such compounds are, for example, hydroxide anions (OH⁻) or water (H₂O).

Below as well as above, reference is made to various anions of oxygen. The above-mentioned oxygen ions having a double negative charge (anions) can, as just described, also be present in a form bound to hydrogen ions without the mode of action of the present invention being adversely affected thereby.

This applies in the same way if reference is made in the context of the present invention to hydrogen peroxide. Here, hydrogen peroxide is therefore understood as meaning both an oxygen molecule having a double negative charge and two oxygen atoms (O₂²⁻) and an oxygen molecule having a double negative charge and two oxygen atoms and a hydrogen ion (HO₂⁻) and an oxygen molecule having a double negative charge and two oxygen atoms and two hydrogen ions (H₂O₂). All abovementioned forms of hydrogen peroxide should not be formed in the process disclosed here.

The process according to the invention makes it possible for the first time to carry out a reduction of the molecular oxygen which is present in molecular form dissolved in the solution having a pH greater than or equal to 8 directly to give oxygen ions having a double negative charge.

Thus, in the process according to the invention, four electrons are transferred on contact of the molecular oxygen with nitrogen-doped carbon nanotubes having a proportion of pyridinic and quaternary nitrogen by means of application of a voltage, so that the desired oxygen ions having a double negative charge are obtained without intermediate formation of hydrogen peroxide taking place.

This is particularly advantageous because, by excluding the possibility of hydrogen peroxide formation, the lifetime of electrodes which are used in the course of the application of the process is prolonged since they are no longer exposed to corrosive attack by the hydrogen peroxide. Moreover, by excluding the presence of a disproportionation reaction according to the formula (IV), owing to the absence of hydrogen peroxide, the yield of the reduction of molecular oxygen to give oxygen ions having a double negative charge is maximized.

The nitrogen-doped carbon nanotubes used in the process according to the invention usually have a diameter of 3 to 150 nm, preferably of 4 to 100 nm and particularly preferably of 5 to 50 nm.

Moreover, the nitrogen-doped carbon nanotubes used in the process according to the invention usually have a ratio of length to diameter (aspect ratio) of at least 2, preferably at least 5, particularly preferably at least 10.

The diameters and aspect ratios according to the invention and preferred diameters and aspect ratios of the nitrogen-doped carbon nanotubes are advantageous since high aspect ratios coupled with the small diameters of the nitrogen-doped carbon nanotubes lead to particularly high specific surface areas per unit mass on nitrogen-doped carbon nanotubes and moreover, in particular, the outer surfaces of the nitrogen-doped carbon nanotubes are particularly suitable for the abovementioned transfer of four electrons according to the formula (III).

In a preferred embodiment of the process according to the invention, the nitrogen-doped carbon nanotubes contain pyridinic and quaternary nitrogen in a ratio greater than or equal to 1, preferably greater than or equal to 1.5, particularly preferably greater than or equal to 2.

In a further preferred embodiment of the process according to the invention, the nitrogen-doped carbon nanotubes for this purpose contain a proportion of greater than 1 atom % of nitrogen.

The abovementioned proportions and modifications can be determined in a generally known manner by the person skilled in the art. As an example of the determination of the modifications and their ratio, electron spectroscopy for chemical analysis (ESCA) may be mentioned. The proportion of nitrogen on the carbon nanotubes is to be adjusted in a simple manner in the course of their preparation by the person skilled in the art.

Without being tied to a theory in this regard, it appears that in particular superficial pyridinic modifications in a certain combination with quaternary modifications will particularly promote electron transfer according to the reaction according to formula (III) in alkaline solutions having a pH greater than or equal to 8.

These pyridinic and quaternary modifications evidently occur to a greater extent in particular in the case of relatively long nitrogen-doped carbon nanotubes (i.e. in the case of those having a particularly high aspect ratio) on the surface of the nitrogen-doped carbon nanotubes.

Whether the reduction of the molecular nitrogen is a reaction according to the formulae (I, II and optionally IV) or a reaction of the molecular oxygen according to the formula (III) can likewise be determined in a simple manner by the person skilled in the art.

A method for this purpose is the recording of so-called Koutecky-Levich diagrams. Although it is said that these methods are generally known, a general description will again be given at this point regarding how the person skilled in the art can make the distinction between a process with the presence of a reaction according to formulae (I, II and optionally IV) and a reaction according to the formula (III).

The determination is based on the formula (V) in which a limiting current (i_{Diff}, [A]) is defined as a function of the number of electrons (n, [-]) of an electrochemical reaction which are exchanged in the reaction on the surface of an annular disc electrode, as are said to be generally known to the person skilled in the art, as a function of the Faraday constant

$$( F \approx 96485.34 \frac{C}{mol} ) ,$$

as a function of the binary diffusion coefficient of the substance to which/from which electrons are taken up by/released to the electrode

$$( D , [ \frac{{m}^{2}}{s} ] )$$

in the electrolyte in which it is present in solution, as a function of the kinematic viscosity of the abovementioned electrolyte

$$( v , [ \frac{{m}^{2}}{s} ] ) ,$$

as a function of the concentration of the substance to which/from which electrons are taken up/released to the electrode in the electrolyte

$$( c , [ \frac{mol}{{m}^{3}} ] ) ,$$

as a function of the area of the annular disc electrode (A, [m²]) and as a function of the rotational speed of the annular disc electrode (ω, [s⁻¹]).

$${i}_{Diff} = 0.63 \cdot n \cdot F \cdot {D}^{\frac{2}{3}} \cdot {υ}^{\frac{1}{6}} \cdot c \cdot A \cdot {ω}^{\frac{1}{2}} \qquad ( V )$$

As is generally known, an electrochemical reaction at an annular disc electrode at relatively high current densities is in the end limited by the oxygen diffusion in the electrolyte surrounding the annular disc electrode, up to the electrode surface. This leads to the designation of i_{Diff} as the limiting current or, based on the electrode surface area A, as limiting current density.

If the limiting current i_{Diff} is determined for an annular disc electrode at different rotational speeds ω of the annular disc electrode and this limiting current i_{Diff} is then plotted as a function of the rotational speed ω of the annular disc electrode, the result is at least an approximate linear dependence according to the formula (VI):

$${i}_{Diff} = K \cdot {ω}^{\frac{1}{2}} \qquad ( VI )$$

The slope of the Koutecky-Levich diagram thus obtained is, in a linearized manner, the constant factor K, which can be read.

The combination of the formulae (IV) and (VI), together with the constant factor K known therewith, leads to a simple mathematical relationship in which only the number of electrons n which are transferred is not known. By simple rearrangement of the equation, the value of n is thus obtained and it is possible thereby to determine whether a reaction according to the formulae (I, II and optionally IV) or according to the formula (III) is present.

The present process is particularly advantageous because, a number of very close to 4 is obtained for n in such a determination for the process according to the invention. In the particularly preferred embodiments of the present invention, the number is even almost exactly 4. Deviations therefrom are due in particular to the values of the constants used, such as, for example F, D and υ, which are present in the formula (IV) and are not completely exact. Moreover, the concentration of oxygen c in solutions having a pH greater than or equal to 8 cannot be determined in the process according to the invention as exactly as would be necessary here for the determination of the exact value 4.

The nitrogen-doped carbon nanotubes used in the process according to the invention and its preferred embodiments can be prepared by the processes according to the prior art if the abovementioned properties of the nitrogen-doped carbon nanotubes are obtained therefrom.

In a preferred embodiment of the present invention, the nitrogen-doped carbon nanotubes are obtained from the processes according to the German patent application with the application number DE 10 2007 062 421.4. Suitable catalysts for the preparation of nitrogen-doped carbon nanotubes are, however, also disclosed in WO 2007 093 337.

In a particularly preferred embodiment of the present invention, the nitrogen-doped carbon nanotubes are obtained from the processes according to the German patent application with the application number DE 10 2007 062 421.4, in which the temperature for the preparation of the nitrogen-doped carbon nanotubes is about 650° C. and in which the starting material comprising carbon and nitrogen is pyridine.

In order to permit very particularly preferred process variants, the abovementioned nitrogen-doped carbon nanotubes are freed below from any residues of catalyst material which are still present.

The freeing can be effected by washing the nitrogen-doped carbon nanotubes with an acid. The acid if preferably hydrochloric acid.

The freeing of the nitrogen-doped carbon nanotubes from the catalyst material is particularly advantageous because, as a result, the residues of catalyst material are no longer available as possible, catalytically active components for the possible reduction of molecular oxygen to hydrogen peroxide according to the formula (II).

In a further particularly preferred embodiment of the process according to the invention for the reduction of molecular oxygen, the nitrogen-doped carbon nanotubes are free of metal or semimetal constituents, such as, for example, Fe, Ni, Cu, W, V, Cr, Sn, Co, Mn and Mo.

The process according to the invention is usually carried out with application of a voltage of +0.2 to −0.8 V between a silver/silver chloride reference electrode (Ag/AgCl reference electrode) and an electrode comprising the abovementioned nitrogen-doped carbon nanotubes having a proportion of pyridinic and quaternary nitrogen, the reduction of the molecular oxygen taking place in the process according to the invention on the surface of the electrode comprising the nitrogen-doped carbon nanotubes having a proportion of pyridinic and quaternary nitrogen. The voltage stated here is based on an Ag/AgCl reference electrode, as is generally known to the person skilled in the art. Starting from this, the conversion to the required voltage between the electrode comprising the abovementioned nitrogen-doped carbon nanotubes having a proportion of pyridinic and quaternary nitrogen and the reference electrode is possible for the person skilled in the art in a simple manner for other reference electrodes.

It was furthermore surprisingly found that the process according to the invention is distinguished by a reduced electrical power consumption at otherwise the same yield of oxygen ions having a double negative charge, which is due, inter alia, to the fact that the transfer of the above-mentioned four electrons in the process presented here takes place even at lower voltages than would be the case in processes according to the prior art, for example using conductive carbon black. This means that the overvoltages observed in the process according to the invention at the electrode surface, which can be observed, are gratifyingly small.

The current densities, expressed in amperes per electrode surface area of the electrode comprising the abovementioned nitrogen-doped carbon nanotubes having a proportion of pyridinic and quaternary nitrogen, depends substantially on the abovementioned voltage or on the abovementioned diffusion rate with application of the abovementioned voltage and, in the process according to the invention or in processes according to the preferred variants, are advantageously high at low voltages since four electrons are transferred in one step even at low voltages.

The abovementioned ranges of voltage and current density are therefore particularly advantageous because, in these ranges, the process according to the invention can be carried out with the use of a minimum quantity of electrical power, measured on the basis of the reduction of molecular oxygen.

In particular, the nitrogen-doped carbon nanotubes used according to the invention and having a proportion of pyridinic and quaternary nitrogen in solutions having a pH greater than 8 permit such a minimization of the energy used by reducing the minimum required voltage for the reduction (the cell voltage).

The present invention furthermore relates to the use of nitrogen-doped carbon nanotubes having a proportion of pyridinic and quaternary nitrogen for the reduction of molecular oxygen in aqueous solutions having a pH greater than 8.

A final subject of the present invention is an electrolysis apparatus for the electrochemical reduction of molecular oxygen to give oxygen ions having a double negative charge, characterized in that it comprises a first electrode space (1), filled with a solution having a pH greater than or equal to 8, in which an electrode (1a) comprising a proportion of nitrogen-doped carbon nanotubes having a proportion of pyridinic and quaternary nitrogen is present, which electrode has an electrically conductive connection via a voltage source (3) to a further electrode (2a) in a further electrode space (2), a membrane (4) being present between the first and the further electrode space.

The process according to the invention can be particularly advantageously carried out in the apparatus according to the invention.

The present invention is illustrated with reference to figures, but without limiting it thereto.

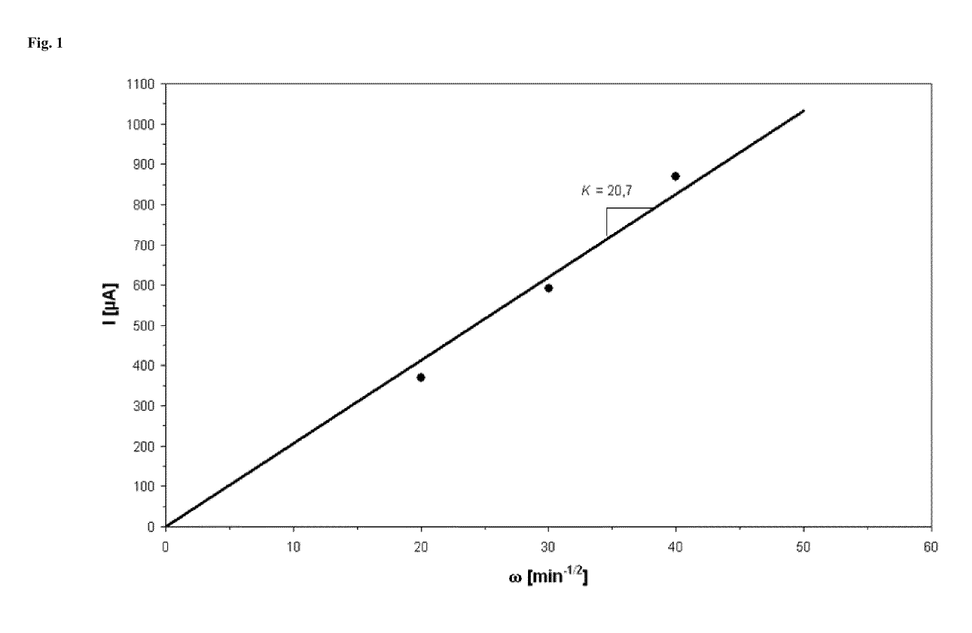

FIG. 1 shows a Koutecky-Levich diagram obtained from the measured data of the process according to the invention according to Example 1. The limiting current i_{Diff} in microamperes is plotted against the square root of the rotational speed

$${ω}^{\frac{1}{2}}$$

of the annular disc electrode in \sqrt{min⁻¹}. The measured points shown relate to the rotational speeds of the annular disc electrode from 400 min⁻¹ through 900 min⁻¹ to 1600 min⁻¹. The line shown is a linear approximation of the determination of the factor K according to the formula (VI), which is obtained as 20.7.

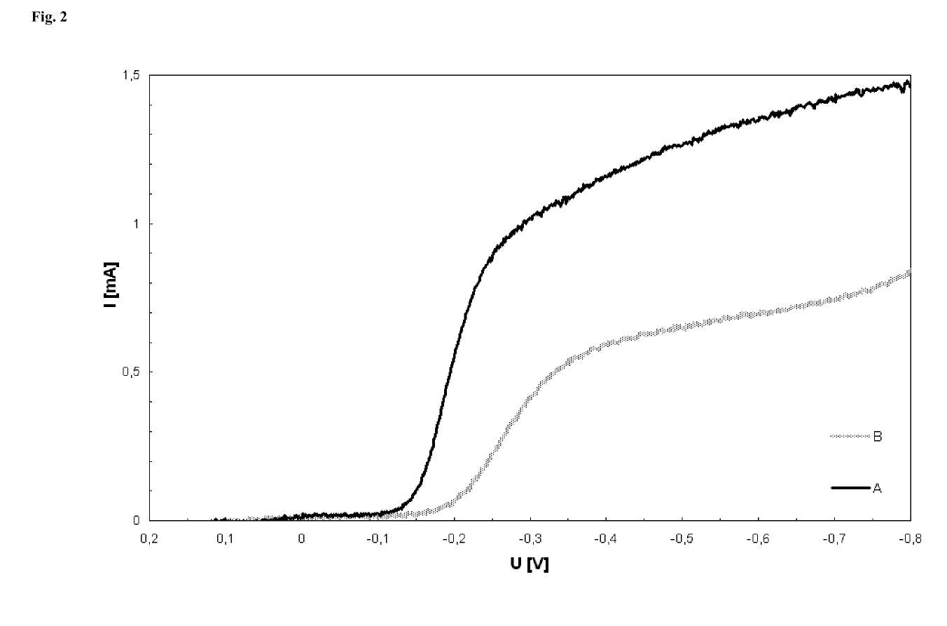

FIG. 2 shows a comparison of the measured data recorded by means of an annular disc electrode against an Ag/AgCl reference electrode at a rotation speed of 3600 min⁻¹ of the annular disc electrode according to Comparative Example 1 (line B) in the case of the process not according to the invention and according to Example 1(line A) in the case of the process according to the invention.

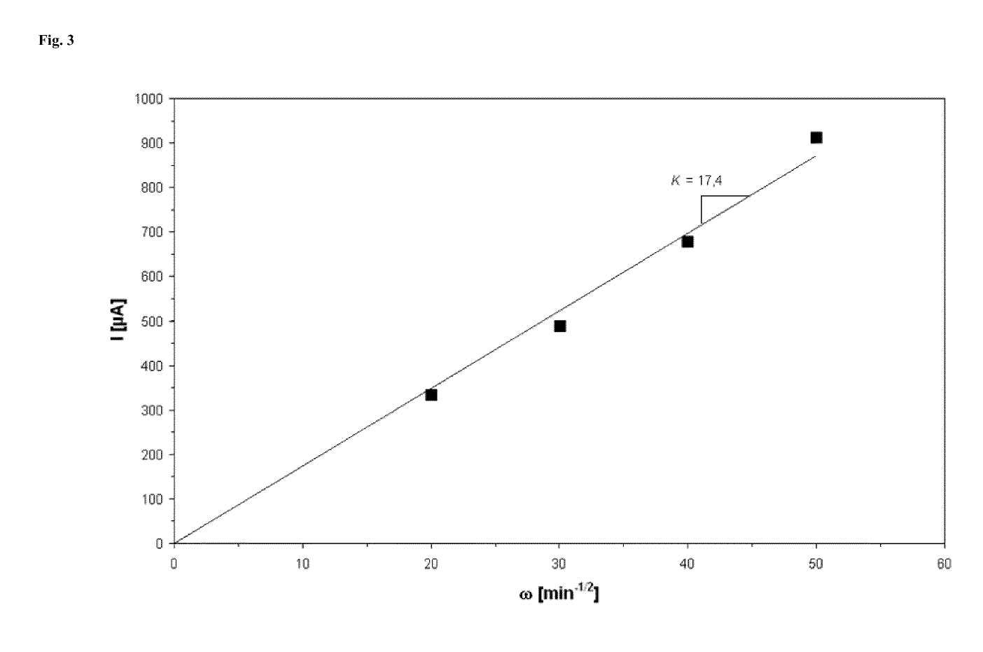

FIG. 3 shows a Koutecky-Levich diagram obtained from the measured data of the process according to the invention, according to Example 2. The limiting current i_{Diff} in microamperes is plotted against the square root of the rotational speed

$${ω}^{\frac{1}{2}}$$

of the annular disc electrode in \sqrt{min⁻¹}. The measured points shown relate to the rotational speeds of the annular disc electrode from 400 min⁻¹ through 900 min⁻¹ and 1600 min⁻¹ to 2500 min⁻¹. The line shown is a linear approximation of the determination of the factor K according to the formula (VI), which is obtained as 17.4.

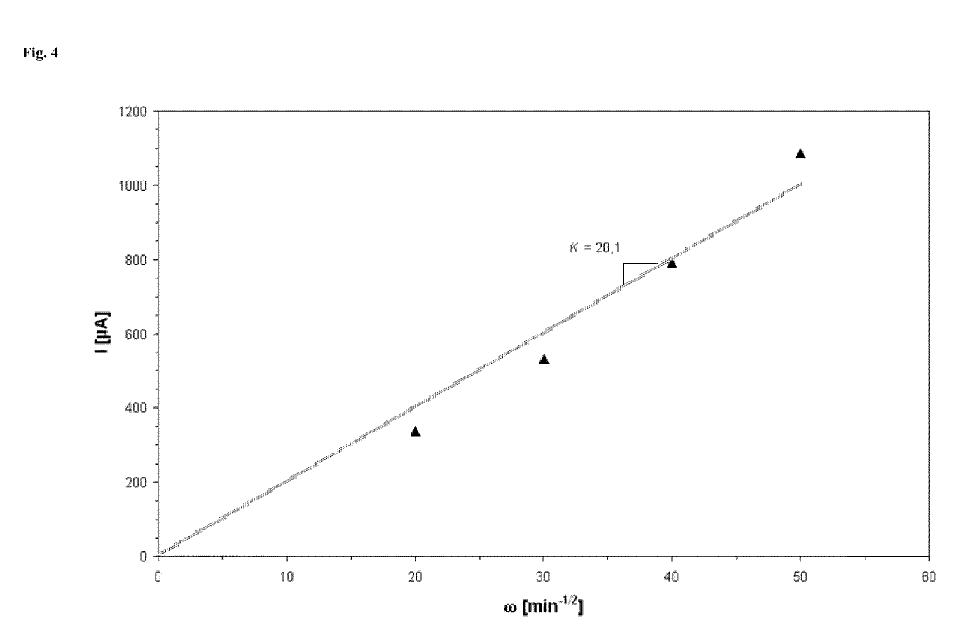

FIG. 4 shows a Koutecky-Levich diagram obtained from the measured data of the process according to the invention, according to Example 3. The limiting current i_{Diff} in microamperes is plotted against the square root of the rotation speed

$${ω}^{\frac{1}{2}}$$

of the annular disc electrode in \sqrt{min⁻¹}. The measured points shown relate to the rotational speeds of the annular disc electrode from 400 min⁻¹ through 900 min⁻¹ and 1600 min⁻¹ to 2500 min⁻¹. The line shown is a linear approximation of the determination of the factor K according to the formula (VI), which is obtained as 20.1.

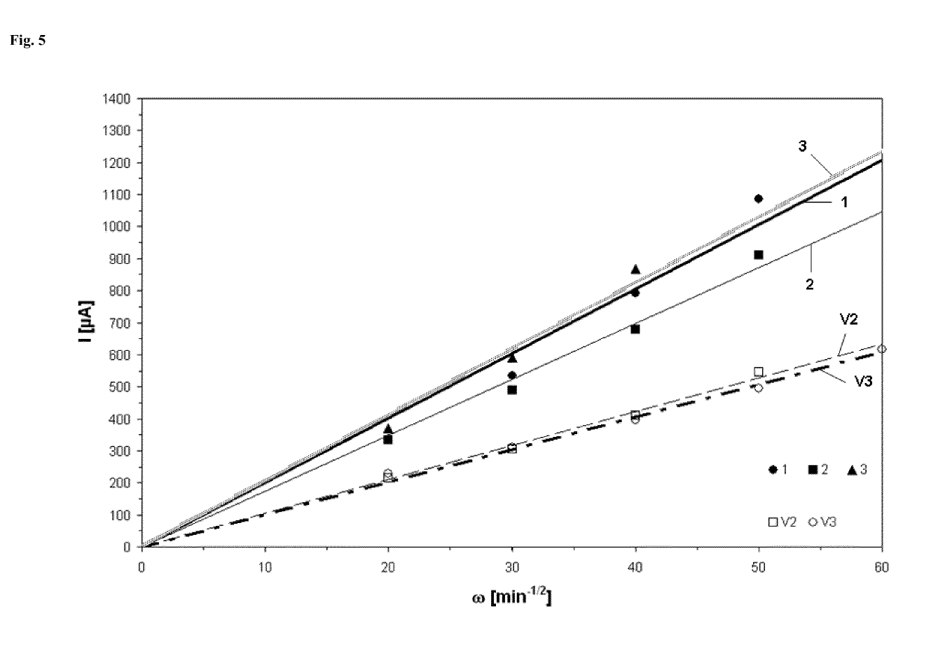

FIG. 5 shows a Koutecky-Levich diagram with all measured data from the process according to the invention, according to Examples 1 to 3, and from the processes not according to the invention, according to Comparative Examples 2 and 3. The data from the process according to the invention, according to Example 1, are shown as solid circles, and the linear approximation thereof for determining the factor K according to the formula (VI) is shown as a thick solid line. The data from the process according to the invention, according to Example 2, are shown as solid squares, and the linear approximation thereof for determining the factor K according to the formula (VI) is shown as a thin solid line. The data from the process according to the invention, according to Example 3, are shown as solid triangles, and the linear approximation thereof for determining the factor K according to the formula (VI) is shown as a shaded solid line. The respective linear approximations of the processes according to the invention, according to Examples 1 to 3, are additionally correspondingly characterized with the numbers 1 to 3. The data from the process not according to the invention, according to Comparative Example 2, are shown as empty squares, and the linear approximation thereof for determining the factor K according to the formula (VI) is shown as a thin dashed line. The data from the process not according to the invention, according to Comparative Example 3, are shown as empty circles, and the linear approximation thereof for determining the factor K according to the formula (VI) is shown as a thick dash-dot line.

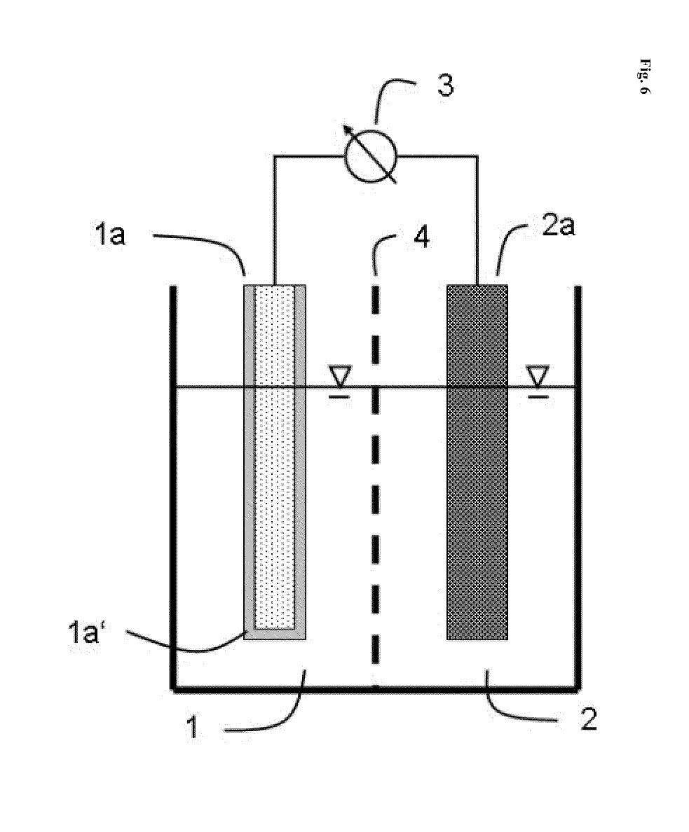

FIG. 6 shows an apparatus according to the invention, having a first electrode (1a) comprising a surface layer (1a′) with nitrogen-doped carbon nanotubes having a proportion of pyridinic and quaternary nitrogen in a first electrode space (1) which is filed with a 0.2 M NaOH solution having a pH of 13.31. Separated therefrom by a membrane (4) is a further electrode space (2) with a titanium electrode (2a), the electrode space (2) being filled with a 0.5% by weight sodium chloride solution and the titanium electrode (2a) having an electric conductive connection via a voltage source (3) to the first electrode (1a).

The present invention is furthermore illustrated in more detail by the following examples, without limiting it thereto.

### EXAMPLES

### Example 1

### Oxygen Reduction According to the Invention

40 mg of nitrogen-doped carbon nanotubes, prepared by catalytic decomposition of pyridine at 650° C. in a fixed-bed reactor, over a cobalt-molybdenum-magnesium oxide catalyst (consisting of 19% by weight of Co, 4% by weight of Mo and 77% by weight of MgO), were first dispersed in 50 ml of acetone after they been freed from catalyst residues by means of washing in concentrated hydrochloric acid solution, so that a first dispersion A was obtained.

The nitrogen-doped carbon nanotubes were investigated beforehand by means of electron spectroscopy for chemical analysis (ESCA; from ThermoFisher, ESCALab 220iXL; method according to the manufacturer's instructions) and by means of transmission electron microscopy (TEM; from FEI, apparatus type: Tecnai20, Megaview III; method according to the manufacturer's instructions).

It was found here that the nitrogen-doped carbon nanotubes had a proportion of 6.5 atom % of nitrogen, that they had a ration of pyridinic to quaternary nitrogen of 2.88, and that they had a median diameter d₅₀ of about 10 nm and a minimum length of about 150 nm, so that they had a aspect ratio of greater than 10.

120 μl of the dispersion A obtained were introduced dropwise onto a polished electrode surface of a rotating annular disc electrode (from Jaissle Elektronik GmbH).

After the evaporation of the acetone, 10 μl of a dissolved sulphonated tetrafluoroethylene polymer (Nafion® solution; from DuPont) were introduced dropwise thereon in a concentration of 26 mg/ml in isopropanol for fixing the solid present in dispersion A.

The rotating annular disc electrode, now comprising the nitrogen-doped carbon nanotubes, was then used as a working electrode in a laboratory cell containing 3 electrodes (working electrode, opposite electrode and reference electrode).

The setup used is known to the person skilled in the art in general as a three-electrode arrangement. A 1 molar NaOH solution in water, which was saturated with oxygen beforehand by means of passing through a gas stream of pure oxygen, was used as an electrolyte surrounding the working electrode.

The reference electrode used was a commercially available Ag/AgCl electrode (from Mettler-Toledo).

The electrolyte was heated to 60° C. The reduction of the oxygen dissolved in molecular form in the electrolyte was likewise carried out at this temperature, which was controlled.

Subsequently, the variation of the limiting current was measured in the range from +0.2 V to −0.8 V, applied between the working electrode and the reference electrode. The above-mentioned range of +0.2 V to −0.8 V was checked at a speed of 10 mV/s.

The measurement of the abovementioned range was carried out analogously several times, the rotational speed of the annular disc electrode being varied in each new experiment.

Altogether, three such measurements were carried out at 400, 900 and 1600 revolutions of the annular disc electrode per minute, for plotting in the Koutecky-Levich diagram of FIG. 1.

The results of the measurement are shown in the form of a Koutecky-Levich diagram in FIG. 1. A value of about 4.2 is obtained from the slope of the linear approximation, using the formulae (V) and (VI) shown above for the number of electrons n transferred in the process. It follows from this, that in the course of the reduction of the oxygen, no hydrogen peroxide was formed in the reaction according to formula (I), which is the result of the abovementioned advantages of the process.

By way of example, a single measurement from the abovementioned Koutecky-Levich diagram is shown in FIG. 2 for a measurement at 3600 revolutions of the annular disc electrode per minute (A) in comparison with the corresponding measurement from Comparative Example 1 (B).

It is evident from this firstly that, on carrying out the process according to the invention in the course of the measurement, a current flow occurs at an applied voltage of only about −0.1 V relative to an Ag/AgCl electrode, whereas, on carrying out the process not according to the invention, this current flow occurs to a significant extent when the applied voltage is about −0.2 V. Thus, the reduction of oxygen in the process according to the invention advantageously occurs earlier than in processes according to the prior art, which leads to a saving of energy for the electrochemical reduction of oxygen. FIG. 2 further shows that the limiting current for the process according to the invention is about twice as high as that of the process not according to the invention. This is due to the abovementioned transfer of four electrons according to the formula (III) in the process according to the invention, whereas only two electrons are transferred according to the formula (I), with formation of hydrogen peroxide, in the process not according to the invention. Accordingly, in the case of the process not according to the invention, an application of an even higher voltage, the further reduction of hydrogen peroxide according to the formula (II) may follow, which is indicated in FIG. 2 in the form of the further bending of the curve at a voltage of about 0.75 V. However, this also implies that the process not according to the invention is always associated with the necessity of applying a higher voltage if a similar yield of oxygen ions having a double negative charge is to be obtained from this process as in the process according to the invention. Thus, such processes are considerably disadvantageous, at least in terms of energy, and as a direct consequence also economically disadvantageous.

### Example 2

### Further Oxygen Reduction According to the Invention

An experiment equivalent to that in Example 1 was carried out, with the only difference that, instead of the nitrogen-doped carbon nanotubes used there, nitrogen-doped carbon nanotubes prepared by catalytic decomposition of pyridine at 650° C. in a fixed-bed reactor over a catalyst corresponding to Example 1 of WO 2007 093 337 were now used. Moreover, measurements were carried out at a rotational speed of the annular disc electrode of 2500 revolutions per minute.

The nitrogen-doped carbon nanotubes were investigated beforehand by means of ESCA. It was found thereby that the nitrogen-doped carbon nanotubes had a proportion of 3.8 atom % of nitrogen and that they had a ratio of pyridinic to quaternary nitrogen of 2.79.

The results of the measurement are shown in the form of a Koutecky-Levich diagram in FIG. 3. A value of about 3.6 is obtained for the number of electrons n transferred in the process from the slope of the linear approximation, using the formulae (V) and (VI) shown above. It follows from this that, in the course of the reduction of the oxygen, no hydrogen peroxide was formed in the reaction according to formula (I) which has the result of the abovementioned advantages of the process.

### Example 3

### Even Further Oxygen Reduction According to the Invention

An experiment equivalent to that in Example 2 was carried out, with the only difference that, instead of the nitrogen-doped carbon nanotubes used there, nitrogen-doped carbon nanotubes prepared by catalytic decomposition of pyridine at 650° C. in a fixed-bed reactor over a catalyst corresponding to Example 2 of WO 2007 093 337 were now used.

The nitrogen-doped carbon nanotubes were investigated beforehand by means of ESCA. It was found thereby that the nitrogen-doped carbon nanotubes had a proportion of 5.8 atom % of nitrogen and that they had a ratio of pyridinic to quaternary nitrogen of 1.61.

The results of the measurement are shown in the form of a Koutecky-Levich diagram in FIG. 4. A value of about 4.1 is obtained for the number of electrons n transferred in the process from the slope of the linear approximation, using the formulae (V) and (VI) shown above. It follows from this that, in the course of the reduction of the oxygen, no hydrogen peroxide was formed in the reaction according to formula (I) which has the result of the abovementioned advantages of the process.

### Comparative Example 1

### Oxygen Reduction not According to the Invention, Using Carbon Black

An experiment equivalent to that in Example 1 was carried out, with the only difference that, instead of the nitrogen-doped carbon nanotubes used there, carbon black (Vulcan XC72, from Cabot) was used.

The comparison between this process not according to the invention and the process according to the invention, according to Example 1, is shown in FIG. 2, the differences having already been explained in the context of Example 1 according to the invention.

### Comparative Example 2

### Further Oxygen Reduction not According to the Invention, Using Other Nitrogen-Doped Carbon Nanotubes

An experiment equivalent to that in Example 1 was carried out, with the only difference that, instead of the nitrogen-doped carbon nanotubes used there, nitrogen-doped carbon nanotubes which, according to ESCA, had a ratio of pyridine to quaternary nitrogen of 0.63 were now used. These nitrogen-doped carbon nanotubes were prepared by catalytic decomposition of pyridine at 750° C. in a fixed-bed reactor over a catalyst corresponding to Example 2 of WO 2007 093 337.

The results of the measurement are shown in the form of empty squares (V2) in the Koutecky-Levich diagram of FIG. 5. A value of about 2.2 is obtained for the number of electrons n transferred in the process according to this comparative example from the slope of the linear approximation of these measured data, which is likewise shown as a thin dashed line in FIG. 5 and is characterized by V2, using the formulae (V) and (VI) shown above.

In comparison with the oxygen reduction according to the invention, according to Examples 1 to 3, which are shown in the form of respective solid lines (1, 2, 3) and in the form of the solid circles, squares and triangles (1, 2, 3), likewise in FIG. 5, the slope of the linear approximation which is only half as great is evident.

It follows from this that, in the course of the reduction of the oxygen according to the comparative example carried out here, a reduction according to the formula (I) with formation of hydrogen peroxide takes place, which is disadvantageous for the abovementioned reasons.

### Comparative Example 3

### Further Oxygen Reduction not According to the Invention, Using Carbon Nanotubes not Doped with Nitrogen

An experiment equivalent to that in Example 1 was carried out, with the only difference that, instead of the nitrogen-doped carbon nanotubes used there, commercially available carbon nanotubes (BayTubes®, from BayTubes) were now used.

The results of the measurement are shown in the form of empty circles (V3) in the Koutecky-Levich diagram of FIG. 5. A value of about 2.1 is obtained for the number of electrons n transferred in the process according to this comparative example from the slope of the linear approximation of the measured data, which is likewise shown as a thin dashed line in FIG. 5 and is characterized by V3, using the formulae (V) and (VI) shown above.

In comparison with the oxygen reduction according to the invention, according to Examples 1 to 3, which are shown in the form of respective solid lines (1, 2, 3) and in the form of the solid circles, squares and triangles (1, 2, 3), likewise in FIG. 5, the slope of the linear approximation which is only half as great is evident.

It follows from this that, in the course of the reduction of the oxygen according to the comparative example carried out here, a reduction according to the formula (I) with formation of hydrogen peroxide takes place, which is disadvantageous for the abovementioned reasons.

1. Process for the electrochemical reduction of molecular oxygen to oxygen ions having a double negative charge in solutions having a pH greater than or equal to 8, which comprises contacting said molecular oxygen in said solutions with nitrogen-doped carbon nanotubes containing pyridinic and quaternary nitrogen under the influence of an applied electrical voltage.

2. Process according to claim 1, wherein the nitrogen-doped carbon nanotubes have a diameter of 3 to 150 nm.

3. Process according to claim 1 or 2, wherein the nitrogen-doped carbon nanotubes have an aspect ratio of at least 2.

4. Process of claim 1, wherein the nitrogen-doped carbon nanotubes have pyridinic and quaternary nitrogen in a ratio greater than or equal to 1.

5. Process according to claim 1, wherein the nitrogen content of the nitrogen-doped carbon nanotubes is greater than or equal to 1 atom %.

6. Process according to claim 1, wherein said voltage is +0.2 V to −0.8 V, measured against an Ag/AgCl reference electrode.

7. (canceled)

8. Electrolysis apparatus for the electrochemical reduction of molecular oxygen to oxygen ions having a double negative charge, comprising a first electrode space (1) filled with a solution having a pH greater than or equal to 8, in which an electrode (1a) comprising nitrogen-doped carbon nanotubes having pyridinic and quaternary nitrogen is present, which electrode has an electrically conductive connection via a voltage source (3) to a further electrode (2a) in a further electrode space (2), a membrane (4) being present between the first and the further electrode spaces.

9. The process of claim 2, wherein said diameter is 4 to 100 nm.

10. The process of claim 9, wherein said diameter is 5 to 50 nm.

11. The process of claim 3, wherein said aspect ratio is at least 5.

12. The process of claim 11, wherein said aspect ratio is at least 10.

13. The process of claim 4, wherein said ratio of pyridinic nitrogen to quaternary nitrogen is greater than or equal to 1.5.

14. The process of claim 13, wherein said ratio of pyridinic nitrogen to quaternary nitrogen is greater than or equal to 2.
